(19) United States
(12) Patent Application Publication
(10) Pub. No.: US 2008/0190111 A1
(43) Pub. Date: Aug. 14, 2008

(54) Thermoacoustic Oscillation Damping In Gas Turbine Combustors With Annular Plenum

(76) Inventor: Stefano Tiribuzi, Pisa (IT)

Correspondence Address: POLLACK, P.C., THE CHRYSLER BUILDING, 132 EAST 43RD STREET, SUITE 760, NEW YORK, NY, 10017, US

(21) Appl. No.: 11/883,823

(22) PCT Filed: Feb. 1, 2006
(86) PCT No.: PCT/EP2006/050604

§ 371 Date: Aug. 4, 2007

(30) Foreign Application Priority Data
Feb. 4, 2005 (EP) 05425050.1

(51) Int. Cl. F02K 1/44

(52) U.S. Cl. 60/725

(57) ABSTRACT

A system for preventing the onset, or mitigating the effect, of thermoacoustic instability in an annular combustor of a premixed combustion gas turbine. A plenum of walls is oriented in a meridian direction so as to obstruct circulation of tangential flows inside the combustor. These walls are desirably situated in suitable azimuthal positions so as to cancel the onset of any standing oscillation mode. In this manner, the walls preferably divide the space in the combustor formed by the plenum asymmetrically. Thus, the resulting annular volumes may extend desirably along selected azimuthal sectors whose angular widths are not multiples of one another.

### DESCRIPTION

1. Field of the Invention

The present invention relates generally to the field of gas turbines using premixed combustion, and refers more specifically to a system for preventing and controlling the pressure fluctuations associated with the combustion instability connected with thermoacoustic phenomena that can occur in combustors with annular plenum chambers in gas turbines equipped with premixed fuel burners.

2. Background Art

The gas turbines, widely used in various industrial fields, comprise three main parts: the compressor, the combustor and the turbine itself. The compressor impeller sucks in and compresses external air, which then flows into the combustor, where fuel is injected and where the combustion reaction takes place. The resulting exhaust gases pass into the turbine, where they drive the turbine impeller, generating more power than was needed to compress the combustion air and thus providing the thrust needed to drive another device. The compressor and turbine impellers are mounted onto one and the same shaft, whose axis constitutes the main turbine axis.

The combustor consists, in turn, of three parts: the plenum chamber, the burners and the combustion chamber. The plenum is the space upstream of the burners into which the compressed air coming from the compressor flows before it is distributed to the various burners. The burners inject the fuel and assure the firm attachment and stability of the flame. Finally, the burner ducts lead into the combustion chamber, where the combustion reaction takes place, and the flow of the resulting exhaust gases are guided in the best conditions towards the turbine inlet.

The combustor may be designed in various ways. The combustors of interest for the purposes of the present invention are equipped with an annular plenum (annular and can-annular combustors).

Of particular interest in terms of the present invention is the annular configuration, wherein the combustion chamber comprises a single toroid-shaped space lying around the gas turbine main axis, with an azimuthally constant meridian cross-section. The term meridian is used to mean the orientation of any plane including the gas turbine main axis. At the longitudinal end of the combustion chamber on the compressor side, there is a row of burners uniformly distributed around the circumference of the chamber, while at the opposite end there is an annular outlet leading to the turbine.

The other combustor configuration of interest for the invention is the can-annular, in which the combustive section comprises an array of tubular combustion chambers (also called cans, or flame tubes) lying circumferentially around the gas turbine main axis and housed inside an annular space (the plenum), which serves the same purpose as in an annular combustor. The fundamental difference between the two types of combustor is the shape of the combustion chamber, which is single and toroidal for an annular combustor, while it is multiple and tubular for a can-annular combustor.

In the early gas turbine models, combustion took place in a diffusive regimen, i.e. the combustive air and fuel gas flowed separately into the combustion chamber and progressively became mixed together due to a mutual diffusion in the respective flows. This process gives rise to the formation of a region lying on the boundary between the two flows where the concentrations of the reagents are in stoichiometric proportions. This region is where the chemical reaction takes place, i.e. the flame is generated. The fact that the stoichiometric region occurs in a specific area lying on the boundary between the two flows enables the flame to remain firmly attached in this precise spatial position, thus improving its stability. However, this stoichiometric condition gives rise to very high flame temperatures, and this induces the formation of nitrogen oxides (NOx), pollutants on which the environmental standards are imposing increasingly strict emission limits.

To reduce the NOx emissions, a premixed combustion process has been adopted in recent years and is now used extensively. This type of combustion consists in premixing fuel and combustive air before they enter the combustion chamber and start to burn, so as to induce the formation of a lean mixture whose combustion takes place in sub-stoichiometric conditions. A lower-temperature flame is thus obtained, thereby reducing the NOx emissions. This premixing is done by injecting the fuel into a specific channel in each burner, in which the combustive air flows.

Unfortunately, premixed combustion has a strongly marked tendency to trigger thermoacoustic instability. This phenomenon occurs when the combustion-associated pressure fluctuations are strengthened by the mechanism of thermoacoustic amplification explained later on. When this happens, the intensity of the pressure fluctuations may increase exponentially until they reach a limit value, which coincides with a condition called the limit cycle, wherein the system's fluid-dynamic dissipation balances the energy contribution due to the thermoacoustic amplification mechanism. The pressure fluctuations are particularly intense in the combustion chamber and give rise to mechanical vibrations, accompanied by the emission of a fierce humming or buzzing sound. In turn, these mechanical vibrations can cause excessive stress in the machine parts, determining its immediate failure or excessive long-term wear.

The method generally used to prevent thermoacoustic instability in premixed combustors involves stabilization of the combustion process by providing each burner with a small diffusive-combustion flame, called pilot flame. Though it is fed with only a small portion of the fuel gas, this flame generates a large portion of the total NOx emitted by the combustor because of the high temperatures developed in it. To comply with the increasingly strict constraints on NOx emissions, gas turbine manufacturers are consequently focusing on finding engineering solutions that enable the portion of gas delivered to the pilot flame to be reduced to a minimum without compromising the combustion stability.

It is common knowledge that sound waves are a physical phenomenon based on the cyclic conversion of the fluido-dynamic energy of a fluid, which alternately changes from potential energy (associated with the pressure) into kinetic energy (associated with the velocity). So there are variations in time and space in these two quantities (pressure and velocity) that take the shape of waves. The pressure and velocity variations in the present context are those occurring around the respective mean values, they are called oscillations or fluctuations.

In an unconfined fluid, waves propagate linearly just like the waves on an unlimited liquid surface, i.e. their crests move in space at a velocity (called the speed of sound), whose value depends on the characteristics of the fluid. In this case, they are called travelling waves.

Locally, i.e. in each given point in space, the pressure and velocity values oscillate in time with a period that depends on the wave's velocity and length (i.e. the geometrical distance between two wave crests).

The acoustic phenomena of interest for the purposes of the present invention become evident in volumes which are delimited by either solid surfaces (walls) and openings with sudden changes in the their fluid flow section. Both these situations constitute points of discontinuity, which behave as acoustic barriers to the physical quantities involved in the phenomenon. The containment walls and sudden passage restrictions act as barriers to the velocity waves, while sudden passage enlargements act as barriers to the pressure waves. A space delimited by acoustic barriers goes by the name of resonant cavity.

When a wave generated in a resonant cavity comes up against such a barrier, it generates a reflected wave that propagates in the opposite direction. When this reflected wave bumps into a barrier on the other side of the cavity, it changes in direction of propagation again and flows in the same direction as the original wave. If this last, twice-reflected wave is in phase with the original wave, intensity of the resulting wave increases, giving rise to a phenomenon of acoustic resonance. When this happens, if the original waves are generated continuously and regularly, then standing waves are created. The shape of standing waves has some points that are fixed in space, called nodes, where the value of the quantities (pressure or velocity) remains constant at a mean value, interspaced with other fixed points, called antinodes, where the value of these quantities changes alternatively between the minimum and maximum values.

Standing waves can only occur at certain wavelengths, such that velocity nodes coincide with the walls or with sudden restrictions of the passage, while pressure nodes coincide with sudden channel enlargements. These various wavelengths are associated with different modes of oscillation, at different frequencies, called acoustic modes of resonance or harmonic modes, identified by a progressive integer, m, or mode order. Harmonic modes are distinguished according to the spatial orientation of the waves and the number of nodes occurring between opposite barriers. The lower-frequency mode, or fundamental mode, corresponds to the higher wavelength and the smallest number of nodes. As the order m increases, so too does the number of the nodes.

When only one mode occurs in a resonant cavity, we speak of a normal harmonic mode oscillation. Moreover there are mixed modes of oscillation, where several harmonic modes are excited simultaneously, even in more than one direction.

For instance, in a parallelepiped acoustic cavity, there may be harmonic modes for each of the three spatial directions, and for each direction there may be modes characterized by a progressively increasing number of nodes distributed along the respective dimension of the resonant cavity.

All combustive systems are affected by acoustic phenomena. The most straightforward situation involves a mainly linear combustor, in which one of the three directions (the one that the gas flows along) prevails over the other two transversal directions. In this configuration—typical of tubular combustion chambers, for instance—the pressure standing waves generated by thermoacoustic instability develop mainly in the longitudinal direction of the chamber, giving rise to longitudinal harmonic modes.

In the case of combustors with annular chambers, in addition to the above-mentioned linear modes developing in the two axial and radial directions of the combustion chamber which are delimited by acoustic barriers, we must also consider the circumferential (or azimuthal) harmonic modes, which give rise to resonance waves oriented in the azimuthal direction of the annular cavity without barriers. In an annular space, in fact, the harmonic components may be reinforced not only by the in-phase overlapping of waves reflected by the barriers at the boundaries, but also by the overlapping of waves propagated along in a closed circle, as in the case of the annular circle. These circumferential modes can occur both as standing waves (as in the linear modes) and in the form of rotating waves, i.e. travelling waves moving in the circumferential direction.

In an annular cavity, the rotating mode pressure wave solidly rotates around the gas turbine axis, i.e. the pressure wave moves azimuthally at a constant angular velocity along any circumference concentric with the axis of the chamber. This pressure wave is coupled with the tangential component alone of the velocity wave.

The circumferential standing wave behaves similarly to the linear standing wave. In this case, there are 2 m pressure nodes located in the circumferential direction of the annular cavity, lying azimuthally equispaced, for each circumferential acoustic mode of order m. At the same time, there are 2 m nodes for the tangential component of the velocity, lying at the pressure antinodes. These standing circumferential acoustic modes can be interpreted as the overlapping effects of two rotating harmonic modes of the same intensity, but moving in opposite directions.

The harmonic characteristics of the thermoacoustic oscillations in an annular combustor were studied analytically in a paper by Krueger et al. “Prediction of thermoacoustic instabilities with focus on the dynamic flame behavior for the 3A-Series gas turbine of Siemens KWU”, ASME 99-GT-111. Judging from the analytical results illustrated therein, the harmonic modes most hazardous to the annular combustor—because they can reach the highest limit cycles—are the circumferential modes, and particularly those with a low order m, with m up to 3. It is set forth in the paper that these results are consistent with observations obtained experimentally during the course of tests conducted on real machines. In these analyses, moreover, although the volume of the plenum is considered in the simulation, it appears to have no particular role in the mechanisms triggering and amplifying instability phenomena.

The role of pressure fluctuations in the plenum in amplifying any thermoacoustic instability is emphasized in the paper by S. Tiribuzi, “CFD modeling of thermoacoustic oscillations inside an atmospheric test rig generated by a DLN burner”, ASME GT2004-53738. The author describes the outcome of numerical simulations, conducted using the CFD (computational fluid dynamic) method, of combustion instabilities generated by a single premixed burner, of the type normally installed in annular combustors. Although the simulated combustion chamber configuration was tubular, not annular, and the harmonic modes reproduced were consequently only axial, the numerical results emphasized the important role of pressure fluctuations in the plenum in sustaining the mechanism responsible for amplifying any thermoacoustic oscillations, a mechanism that is described here below. The phase difference between the pressure fluctuations in the plenum and in the combustion chamber accentuates the amplitude of the pressure difference oscillations across the burner premixing channel. These oscillations determine a synchronous fluctuation in the air flow rate variation in premixing channel, which gives rise to fuel mixture enrichment fluctuations, because the flow rate of the injected premixing fuel is essentially constant. When a pocket of richer mixture flows downstream and reaches the flame zone, its combustion prompts a heat emission peak which—if it is in phase with a pressure peak in the combustion chamber—further increases the fluctuation entity of this latter quantity. The thermoacoustic instability thus becomes self-exciting, gradually amplifying the pressure oscillations until the limit cycle is reached.

The same CFD method used in the above-mentioned study by S. Tiribuzi was also used to analyze the configuration of the acoustic modes in an annular combustor. These simulations reproduced the circumferential modes described in the previously mentioned ASME paper 99-GT-111 and it emerged that the dominant modes appear to be those of order m=2 with both a rotating component and a standing component. These simulations also confirmed the important effect of pressure fluctuations in the plenum on the mechanism behind the increase in thermoacoustic instability. In fact, it became clear that circumferential waves, of the same type as those generated in the combustion chamber, form in the plenum too. This synchronism between fluctuations in the plenum and combustion chamber determines, for each burner, the same situation as described in the previously-mentioned ASME article GT2004-53738, with a progressive amplification in the amplitude of the fluctuations until the limit cycle is reached. The pressure fluctuations across the various burners combine together in the annular spaces situated at the end sides of the burners, i.e. in the plenum and in the combustion chamber (in the case of the latter, this only applies to annular combustors).

Many methods have been developed by gas turbine manufacturers in an attempt to contrast the onset of thermoacoustic instability in premixed flame combustors. An up-to-date review of the state of the art is given in the paper by T. Lieuwen et al. “Recent progress in predicting, monitoring and controlling combustion driver oscillations in gas turbine”, published in the Proceedings of the POWER-GEN International Congress 2003. These methods can be divided into two main types: passive and active.

The passive methods can be further divided into various sub-types including:
operational alterations to the azimuthal symmetry achieved by differentiating the working parameters of adjacent burners, e.g. by slightly varying the proportions of air delivered to the respective pilot flames;
structural changes to alter the symmetry of the response characteristics of the various burners, e.g. by applying extensions to the burner outlet;
adjusting the acoustic properties of the burner gas feed lines, so that the fuel delivery is out of phase with the thermoacoustic oscillations in the combustion chamber;
installing Helmholtz resonators or other similar devices facing them onto the combustion chamber, to obtain a damping effect on the acoustic frequencies considered most hazardous.

As for the active control methods, these are based mainly on a controlled modulation of part of the fuel flow so that it is out of phase with the oscillations.

Moreover, numerous patents concern the control of thermoacoustic instability in gas turbine combustors, which goes to show how much importance is attributed to this aspect of the technology and how difficult it is to find adequate solutions for dealing globally with the problem.

An example of a passive method is described in the patent U.S. Pat. No. 6,536,204, which suggests a burner configuration for an annular combustor, wherein a cylindrical element is attached to at least some of said burners that protrudes their outlet into the combustion chamber. This solution should prevent, or at least attenuate, the combustion instability by placing the combustion chamber/burner system out of phase by altering the acoustic characteristics of the two to a different degree. This method has no effect, however, on the element upstream of the burners, the plenum, which (as seen earlier) is what enables the acoustic coupling between the burners. This method also introduces additional structural members inside a cavity (the combustion chamber) where high temperatures develop, thus exposing said components to the risk of considerable damage.

All the above-mentioned methods fail, moreover, to prevent or contain the onset of circumferential oscillations in the plenum, which (as stated previously) play an important part in the evolution and amplification of thermoacoustic oscillations. As regards the active methods, the quoted article by T. Lieuwen et al. makes the point that manufacturers are also rather reluctant to use them because of their complexity, cost and dubious reliability.

### OBJECT AND SUMMARY OF THE INVENTION

The general object of the present invention is to prevent the onset of circumferential combustion instabilities, or at least to considerably reduce their entity, in gas turbine combustors equipped with premixed flame burners by means of an original passive method.

A particular object of the present invention is to prevent the onset, or at least reduce the amplitude, of circumferential harmonic modes in the annular plenum of the gas turbine combustor, so as to eliminate one of the elements involved in the above-described chain mechanism responsible for amplifying the thermoacoustic instability, but without interfering with the normal flow of combustive air into the plenum.

Another object of the present invention is to provide a gas turbine with an annular combustor, wherein the onset of both rotating and standing circumferential harmonic modes in the plenum is prevented, or their amplitude is at least reduced.

According to the present invention, these objects are achieved by contrasting the propagation of circumferential waves in the annular space of the plenum, by inserting walls lying transversally to the azimuthal direction that interfere with the gaseous flow in said direction. Since the acoustic phenomena are characterized by the coupling of pressure waves and velocity waves, interfering with the flow of the fluid also prevents the evolution of pressure waves in the same direction.

As already mentioned, the most hazardous acoustic modes in the case of annular cavities (such as the combustion chamber and plenum of an annular combustor) are the circumferential modes, i.e. those associated with the pressure waves fluctuating in the azimuthal direction of the cavity, because they are the easiest to trigger and amplify. These waves are coupled with oscillations in the tangential component of the velocity of the fluid in the annular cavity. As a consequence, obstructing the flow in this direction (by inserting walls with a meridian orientation) will also hinder the formation of the pressure waves associated with the circumferential modes.

In terms of the present invention, the walls are most effective if they cover the whole meridian section of the plenum, though a lesser extension can still have a useful damping effect. The walls can be solid, or moderately perforated, should it be necessary to rebalance the pressures between the various sectors of the plenum. The mechanical stiffness of the walls must be sufficient to avoid acoustic waves being transmitted between adjacent plenum sectors.

Thanks to their substantially meridian orientation, the walls do not affect with the normal flow of combustive air in the plenum because they lie parallel to the air's normal flow lines.

One of the advantages of the present invention is that action is taken in a part of the gas turbine, the plenum, that is upstream of the burners, where the temperature is consequently still not high enough to pose a problem as regards the thermal resistance of the materials.

A further advantage of this solution, which is not true of the majority of the known solutions relating to the same issue, is that it demands only minimal modifications to the combustor's design and is consequently easy to implement in current models of gas turbine, even in already-installed machines.

### BRIEF DESCRIPTION OF THE DRAWINGS

Further characteristics and advantages of the gas turbine according to the present invention will become more clearly apparent from the following description of an embodiment of the same, given as a non-limiting example with reference to the attached drawings, wherein:

FIG. 1 shows a schematic longitudinal meridian section of a gas turbine with an annular combustor;

FIG. 2 shows a schematic longitudinal meridian section of the gas turbine according to the invention;

FIG. 3 shows a cross-section of the plenum in the annular combustor equipped with four walls of the type schematically illustrated in FIG. 2;

FIGS. 4a, 4b and 4c show how a circumferential rotating wave evolves for the first three harmonic modes m=1,2,3, while FIGS. 4d, 4e and 4f show how a circumferential standing wave develops for the first three harmonic modes m=1,2,3;

FIG. 5 shows a diagram with the trend of the instantaneous power calculated during the numerical simulation of the base case (without walls), superimposed to the trend of the same power calculated for the configuration represented in FIG. 3.

### DETAILED DESCRIPTION OF THE INVENTION

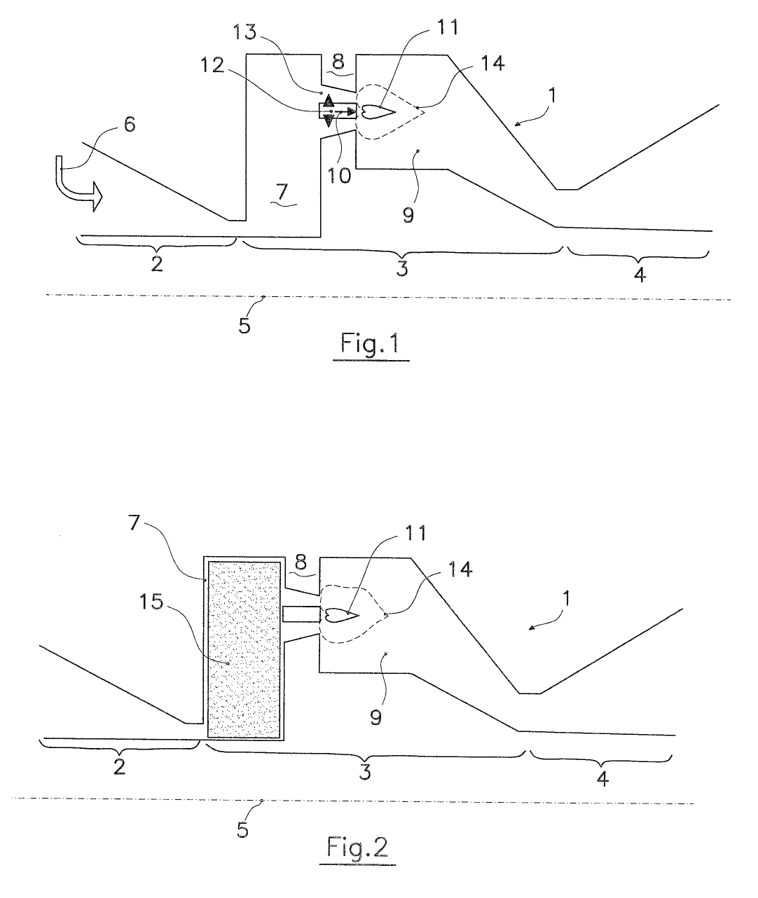

With reference to FIG. 1, which schematically shows the meridian section of a gas turbine unit generically indicated by the reference number 1, with an annular combustor according to current technology. The gas turbine unit 1 essentially comprises three parts: a compressor 2, a combustor 3 and the turbine 4 itself. These parts have an axisymmetric configuration around a central axis, also called the main axis 5 of the gas turbine unit 1. The compressor 2 sucks in combustive air 6 from outside, compressing it and sending it to the combustor 3. The combustor 3 in turn comprises three parts: the plenum 7, a row of burners 8, lying equispaced from each other around the gas turbine axis 5, and the combustion chamber 9. The compressed air coming from the compressor 2 flows inside the plenum 7, which is a toroid-shaped cavity, before it is distributed to the various burners 8. The burners 8 are for injecting the fuel and ensuring the attachment and stability of the flame. A minor amount of fuel 10 is delivered to a pilot flame 11. The remainder of fuel 12 is injected into a premixing channel 13, where it is mixed with the combustive air coming from the plenum 7. The resulting lean fuel mixture feeds a premixed flame 14.

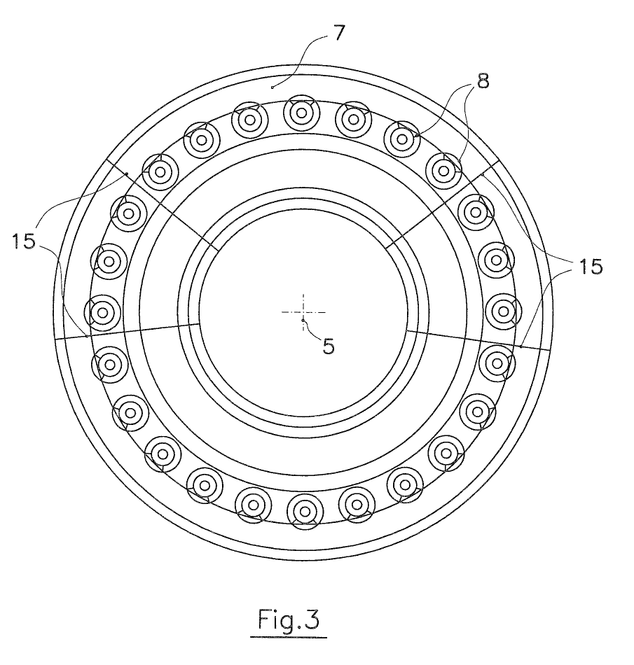

Referring now to FIGS. 2 and 3, according to a preferred embodiment of the invention, four walls 15 are provided inside the plenum 7, extending over the full meridian section of said plenum 7. As illustrated in FIG. 3, the four walls are preferably arranged so as to divide the space in the plenum asymmetrically into annular sectors, avoiding the angular widths of adjacent sectors from being the same or multiples of each other, if possible. In particular, a straightforward and practical way to divide the space in the plenum is to arrange the walls 15 so that each sector contains a prime number of burners, as in the embodiment illustrated where the angular spacing of the walls 15 is such as to include three, seven, three and eleven burners 8 between two successive walls.

Of course, the number of walls can differ from the solution described above. Even a single wall may suffice to disrupt the rotating circumferential modes, but not the standing modes. As mentioned previously, both these types of fluctuations can occur in an annular combustor.

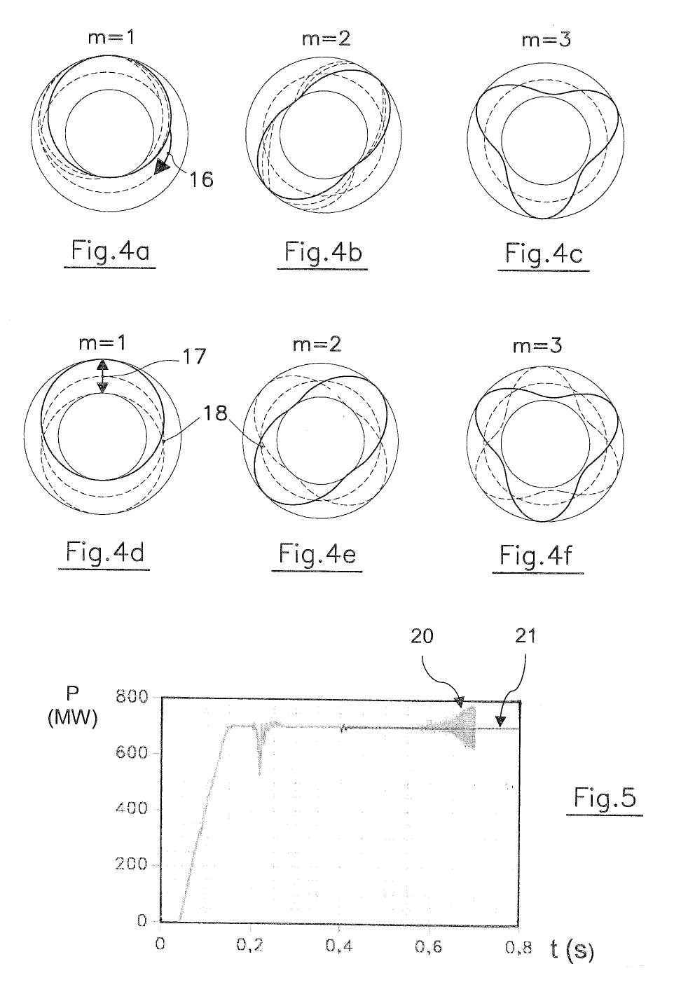

FIGS. 4a, 4b and 4c show the first three rotating circumferential modes, indicating the waveform's rotating direction 16. FIGS. 4d, 4e and 4f, on the other hand, represent the first three standing circumferential modes, showing the antinodes 17 and the nodes 18.

For a rotating acoustic mode, the tangential velocity wave crests (i.e. the points where said velocity is maximum in modulus) move azimuthally, passing through all the angular positions. It is consequently evident that the presence of any number (even only one) and arrangement of meridian walls interferes with the propagation of the circumferential spinning mode velocity wave because each wall hinders the gaseous flow in the tangential direction.

However, inserting just one wall may not prevent the formation of standing circumferential modes, since one of the 2 m nodes of the tangential velocity standing wave may coincide with the wall. Likewise, inserting n walls in an equal number of azimuthal positions does not prevent the onset of those acoustic modes in which the distribution of the 2 m nodes is such that the n walls all happen to coincide with a tangential velocity wave node.

Thus, although any azimuthal arrangement of meridian walls can counter the onset of rotating circumferential modes in the plenum, for the solution to effectively obstruct the standing circumferential modes too, the walls must circumferentially divide the space in the plenum asymmetrically, so as to prevent standing circumferential mode velocity wave nodes from coinciding with the walls.

In still another embodiment of the invention, the walls 15 may have different longitudinal extensions and not necessarily occupy the whole section of the plenum. In another embodiment of the invention, the walls may also be arranged in two or three arrays placed in different parts of the meridian section of the plenum.

The walls 15 may be solid or partially or completely perforated, so as to enable modest azimuthal flows to rebalance any pressure asymmetries.

The effectiveness of the system for controlling combustion instability based on the invention has been tested numerically using the same method as described in the previously-mentioned paper by S. Tiribuzi, but applied to a realistic annular combustor of industrial type and size. This method enables a simulation (i.e. a virtual numerical modeling) of the likely thermo-fluido-dynamic behavior of a combustor. Each simulation of a given geometric and operational arrangement constitutes a case.

Using the same geometrical configuration, consistent with an annular combustor of industrial size, a base case was simulated in nominal machine conditions, i.e. under full load, but using calculation parameters calibrated to facilitate the onset of thermoacoustic instability. As illustrated in FIG. 5, the transient was protracted for 0.8 s real time, starting from initial no-flow conditions. The instantaneous power curve for the period simulated shows that ample thermoacoustic oscillations are triggered spontaneously and progressively amplify until they become stabilized in a limit cycle.

As mentioned earlier, this simulation demonstrated that, for the particular configuration examined, the dominant mode associated with the fluctuations was circumferential of order 2, with four pressure nodes and four velocity nodes lying alternately around the circumference of the annular cavity. Said circumferential mode also has both a rotating component and a standing component.

To ascertain the effectiveness of the proposed system, a case was subsequently simulated using a configuration according to the invention, as shown in FIGS. 2 and 3, with four walls 15 inserted in the plenum 7, lying on a corresponding number of meridian planes between burners so as to divide the annular space in the plenum into four sectors of a circle comprising three, seven, three and eleven burners. The walls were extended to cover the full meridian section of the plenum.

In this case, the transient was started at the instant +0.4 s of the base case. Combustor function remained absolutely stable, with no thermoacoustic oscillations, as demonstrated by the constant trend of the instantaneous power in the diagram described below, thus confirming the effectiveness of the proposed system.

The combustor different behavior in the two cases (base and with walls) is emphasized in FIG. 5, which plots the power curves calculated during the numerical simulations performed using CFD methodology on an annular combustor of industrial shape and size. In particular, the diagram shows a base curve 20 describing the trend calculated in the base case (without walls), with clear evidence of the onset, beyond the initial ramp, of pressure fluctuations that increase progressively up to the limit value. Superimposed on said curve, there is another curve 21 relating to the case in which walls 15 are inserted in the plenum 7 according to the preferred embodiment of the invention, which illustrates the stabilization of the combustor fluid dynamic behavior.

The system according to the present invention for controlling combustion instability in gas turbines with annular combustors can be extended to gas turbines with can-annular combustors too. In these combustors as well, acoustic couplings among the various flame tubes can occur through the plenum, though, due to the absence of any circumferential acoustic modes in the combustion chamber, the modes derive in this case from a coupling between axial modes in the single tubular combustors and circumferential modes in the plenum. Here again, the arrangement of the walls follows the same criteria as for annular combustors. Each wall can cover all or only a part of the meridian section of the plenum. The walls must be inserted between adjacent flame tubes so as to divide the plenum into circular segments each comprising a integer number of flame tubes. The number of flame tubes in each section must be such as to divide the plenum volume into asymmetrical sectors.

Numerous modifications and variations of the invention may be conceived on the basis of the above description on the understanding that any such modifications and variations do not depart from the spirit and scope of the invention as laid out in the following claims.

What is claimed is:

1. A combustor for a premixed combustion gas turbine, comprising an annular plenum, into which compressed air flows from a gas turbine compressor, a plurality of burners for fuel injection arranged about a turbine axis, among which burners the compressed air delivered to the plenum is distributed, and a combustion chamber downstream of the burners, wherein at least one wall of the plenum is oriented along a substantially meridian section configured so as to interfere with tangential flows in the combustor, and thereby hinder the onset of rotating circumferential modes of thermoacoustic oscillations inside the combustor.

2. The combustor set forth in claim 1, wherein a plurality of walls are inserted into the plenum in varying azimuthal positions so as to divide space in the plenum asymmetrically and, thereby, prevent the onset of standing modes of oscillation.

3. The combustor set forth in claim 2, wherein the walls divide the plenum into annular sectors such that the angular widths of adjacent sectors are not multiples of one another.

4. The combustor set forth in claim 3, wherein each of the annular sectors contains a prime number of burners.

5. The combustor set forth in claim 1, wherein the extension of the walls covers substantially the meridian section of the plenum.

6. The combustor set forth in claim 1, wherein the extension of the walls covers only a portion of the meridian section of the plenum.

7. The combustor set forth in claim 1, wherein the walls are at least partially perforated to enable relatively modest azimuthal flows and, thereby, rebalance any pressure asymmetries.

8. The combustor set forth in claim 1, wherein the combustion chamber is of an annular type.

9. The combustor set forth in claim 1, wherein the combustor is of a can-annular type and the combustion chambers are of a tubular type.
